(19) United States
(12) Patent Application Publication
(10) Pub. No.: US 2013/0249705 A1
(43) Pub. Date: Sep. 26, 2013

(54) CASING COLLAR LOCATOR WITH WIRELESS TELEMETRY SUPPORT

(71) Applicants: David P. SHARP, Houston, TX (US); John L. Maida, Houston, TX (US); Etienne M. Samson, Cypress, TX (US)

(72) Inventors: David P. SHARP, Houston, TX (US); John L. Maida, Houston, TX (US); Etienne M. Samson, Cypress, TX (US)

(73) Assignee: Halliburton Energy Services, Inc., Duncan, OK (US)

(21) Appl. No.: 13/426,414

(22) Filed: Mar. 21, 2012

(51) Int. Cl. G01V 3/00

(52) U.S. Cl. 340/854.7

(57) ABSTRACT

Disclosed are wireline tool systems including a casing collar locator tool and one or more logging tool(s). The logging tool(s) collects information regarding a formation property or a physical condition downhole, and produces a modulated magnetic field to communicate at least some of the collected information. The casing collar locator tool includes a light source and a sensor. The light source transmits light along an optical fiber in accordance with a sensor signal. The sensor produces the sensor signal in response to magnetic field changes attributable to passing collars in a casing string, and to the modulated magnetic field produced by the logging tool(s). Related telemetry methods are also described.

### BACKGROUND

After a wellbore has been drilled, the wellbore is often cased by inserting lengths of steel pipe (“casing sections”) connected end-to-end into the wellbore. Threaded exterior rings called couplings or collars are typically used to connect adjacent ends of the casing sections at casing joints. The result is a “casing string”, i.e., a series of casing sections with connecting collars that extends from the surface to a bottom of the wellbore. The casing string is then cemented in place to complete the casing operation.

After a wellbore is cased, the casing is often perforated to provide access to a desired formation, e.g., to enable formation fluids to enter the well bore. Such perforating operations require the ability to position a tool at a particular and known position in the well. One method for determining the position of the perforating tool is to count the number of collars that the tool passes as it is lowered into the wellbore. As the length of each of the steel casing sections of the casing string is known, correctly counting a number of collars or joints traversed by a device as the device is lowered into a well enables an accurate determination of a depth or location of the tool in the well. Such counting can be accomplished with a casing collar locator (“CCL”), an instrument that may be attached to the perforating tool and suspended in the wellbore with a wireline. A wireline is an armored cable having one or more electrical conductors to facilitate the transfer of power and communications signals between the surface electronics and the downhole tools. Such cables can be tens of thousands of feet long and subject to extraneous electrical noise interference and crosstalk. In certain applications, the detection signals from conventional casing collar locators and/or data signals from wireline logging tools may not be reliably communicated via the wireline.

### BRIEF DESCRIPTION OF THE DRAWINGS

Accordingly, there are disclosed in the drawings and the following description specific embodiments of downhole systems and methods for casing collar location with combined communications support for other downhole instruments. In the drawings:

FIG. 1 shows an illustrative wireline tool system including a casing collar locator (CCL) tool;

FIG. 2 shows a first illustrative CCL tool embodiment;

FIG. 3 is an illustrative coil response to a passing casing collar;

FIG. 4 shows an illustrative optical interface for the CCL tool;

FIG. 5A shows a second illustrative CCL tool embodiment;

FIG. 5B is a top view of an illustrative ferrite “star”;

FIG. 6 shows a third illustrative CCL tool embodiment;

FIG. 7 shows a fourth illustrative CCL tool embodiment;

FIG. 8 shows an illustrative interface schematic for bi-directional communication; and

FIG. 9 is a flowchart of an illustrative telemetry method.

It should be understood, however, that the specific embodiments given in the drawings and detailed description thereof do not limit the disclosure. On the contrary, they provide the foundation for one of ordinary skill to discern the alternative forms, equivalents, and modifications that are encompassed together with one or more of the given embodiments in the scope of the appended claims.

### DETAILED DESCRIPTION

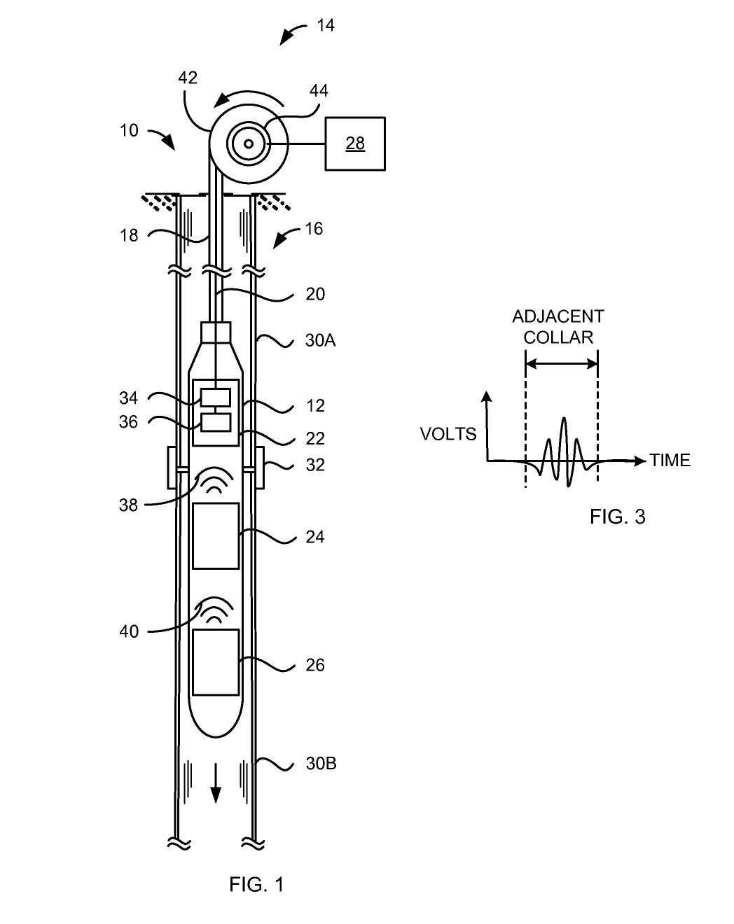

Turning now to the figures, FIG. 1 provides a side elevation view of a well 10 with an illustrative wireline tool system 14 including a sonde 12 suspended in the well 10 by a fiber optic cable 18 having one or more optical fiber(s) 20. The well 10 is cased with a casing string 16 having casing sections 30A and 30B connected end-to-end by a collar 32. As is typical, the casing sections 30 of the casing string 16 and the collars connecting the casing sections 30 (e.g., the collar 32) are made of steel, an iron alloy, and hence it exhibits a fairly high magnetic permeability and a relatively low magnetic reluctance. In other words, the casing string material conveys magnetic field lines much more readily than air and most other materials.

The illustrated sonde 12 houses a casing collar locator (CCL) tool 22 and two logging tools 24 and 26. A surface unit 28 is coupled to the sonde 12 via the fiber optic cable 18 and configured to receive optical signals from the sonde 12 via the optical fiber(s) 20. In the embodiment of FIG. 1, the CCL tool 22 is configured to generate an electrical “location” signal when passing a collar of the casing string 16, to convert the electrical location signal into an optical location signal, and to transmit the optical location signal to the surface unit 28 via the optical fiber(s) 20 of the fiber optic cable 18. As described in more detail below, the CCL tool 22 is also configured to receive electromagnetic telemetry signals (e.g., from the logging tools 24 and 26), to convert the electromagnetic telemetry signals into optical telemetry signals, and to transmit the optical telemetry signals along with the optical location signal to the surface unit 28 via the optical fiber(s) 20 of the fiber optic cable 18.

In the embodiment of FIG. 1, the CCL tool 22 includes an optical interface 34 coupled to the optical fiber(s) 20, and a sensor 36 coupled to the optical interface 34. The sensor 36 produces an electrical signal in response to magnetic field changes attributable to passing collars (e.g., the collar 32) in the casing string 16. In some embodiments, the CCL tool 22 includes one or more permanent magnet(s) producing a magnetic field that changes when the CCL tool 22 passes a collar, and the sensor 36 includes a coil of wire (i.e., a coil) positioned in the magnetic field to detect such changes. As the CCL tool 22 passes a collar, the resultant change in the strength of the magnetic field passing through the coil causes an electrical voltage to be induced between the ends of the coil (in accordance with Faraday's Law of Induction). This induced electrical signal is the electrical “location” signal referred to above. In other embodiments, the sensor 36 may include, for example, a magnetometer or a Hall-effect sensor.

The logging tools 24 and 26 are configured to gather information regarding a formation property or a physical condition downhole. For example, the logging tools 24 and 26 may be configured to gather information about the casing string 16 and/or the well 10, such as electrical properties (e.g., resistivity and/or conductivity at one or more frequencies), sonic properties, active and/or passive nuclear measurements, dimensional measurements, borehole fluid sampling, and/or pressure and temperature measurements. The logging tools 24 and 26 generate electromagnetic telemetry signals conveying gathered information.

For example, in the embodiment of FIG. 1, the logging tool 24 produces a modulated magnetic field 38 such that the magnetic field 38 conveys information gathered by the logging tool 24. In one implementation, logging tool 24 may produce the magnetic field 38 such that the magnetic field has a magnitude and direction that varies sinusoidally, and has a base frequency, phase, and amplitude. The logging tool 24 varies or modulates the base frequency, the phase, or the amplitude of the magnetic field 38 dependent upon the information to be transmitted. Similarly, the logging tool 26 produces a modulated magnetic field 40 such that the magnetic field 40 conveys information gathered by the logging tool 26. The modulation can be performed in digital or analog fashion, and with an appropriate multiplexing scheme (e.g., time division or frequency division), the modulation scheme can be determined independently by each tool.

The strengths of the modulated magnetic fields 38 and 40 produced by the respective logging tools 24 and 26 are chosen to ensure that sensor 36 produces responds to changes in the magnetic fields 38 and 40 with electrical signals that correspond to the electromagnetic telemetry signals produced by the respective logging tools 24 and 26. As a result, the combined electrical signal produced by the sensor 36 includes the electrical location signal, attributable to passing collars in the casing string 16, and electrical telemetry signals attributable to the electromagnetic telemetry signals transmitted by the logging tools 24 and 26.

The optical interface 34 of the CCL tool 22 includes a light source controlled or modulated by the electrical signal received from the sensor 36, thereby producing an optical signal. The light source may include, for example, an incandescent lamp, an arc lamp, an LED, a semiconductor laser, or a super-luminescent diode. The optical signal produced by the optical interface 34 includes a optical location signal produced in response to the electrical location signal, and optical telemetry signals produced in response to the electromagnetic telemetry signals from the logging tools 24 and 26. The optical interface 34 transmits the optical signal to the surface unit 28 via the optical fiber(s) 20 of the fiber optic cable 18. The surface unit 28 processes the optical signal received via the optical fiber(s) 20 to obtain a casing collar locator signal and telemetry signals (i.e., transmitted information) from the logging tools 24 and 26.

In at least some embodiments, the surface unit 28 includes a photodetector that receives the optical signal and converts it into an electrical signal (e.g., a voltage or a current) dependent on a magnitude of the optical signal. The photodetector may be or include, for example, a photodiode, a photoresistor, a charge-coupled device, or a photomultiplier tube.

In some embodiments, the resultant electrical signal spans a frequency range, and the casing collar locator signal occupies a first portion of the frequency range. The modulated magnetic field 38 produced by the logging tool 24 occupies a second portion of the frequency range, and the modulated magnetic field 40 produced by the logging tool 26 occupies a third portion of the frequency range. The surface unit 28 recovers the casing collar locator signal from the first portion of the frequency range, the telemetry signal from the logging tool 24 from the second portion of the frequency range, and the telemetry signal from the logging tool 26 from the third portion of the frequency range.

In the embodiment of FIG. 1, the fiber optic cable 18 preferably also includes armor to add mechanical strength and/or to protect the cable from shearing and abrasion. Some of the optical fiber(s) 20 may be used for power transmission, communication with other tools, and redundancy. The fiber optic cable 18 may, in some cases, also include electrical conductors if desired. The fiber optic cable 18 spools to and from a winch 42 as the sonde 12 is conveyed through the casing string 16. The reserve portion of the fiber optic cable 18 is wound around a drum of the winch 42, and the fiber optic cable 18 having been dispensed or unspooled from the drum supports the sonde 12 as it is conveyed through the casing string 16.

In the illustrated embodiment, the winch 42 includes an optical slip ring 44 that enables the drum of the winch 42 to rotate while making an optical connection between the optical fiber(s) 20 and corresponding fixed port(s) of the slip ring 44. The surface unit 28 is connected to the port(s) of the slip ring 44 to send and/or receive optical signals via the optical fiber(s) 20. In other embodiments, the winch 42 includes an electrical slip ring 44 to send and/or receive electrical signals from the surface unit 28 and an electro-optical interface that translates the signals from the optical fiber 20 for communication via the slip ring 44 and vice versa.

In certain alternative embodiments, the logging tool 26 does not communicate directly with CCL tool 22, but rather communicates indirectly via logging tool 24 using the magnetic field 40, another form of wireless communication, or one or more wired connections. The logging tool 26 may provide gathered information to the logging tool 24, and the logging tool 24 may modulate the magnetic field 38 to produce an electromagnetic telemetry signal that conveys information gathered by both the logging tool 24 and the logging tool 26.

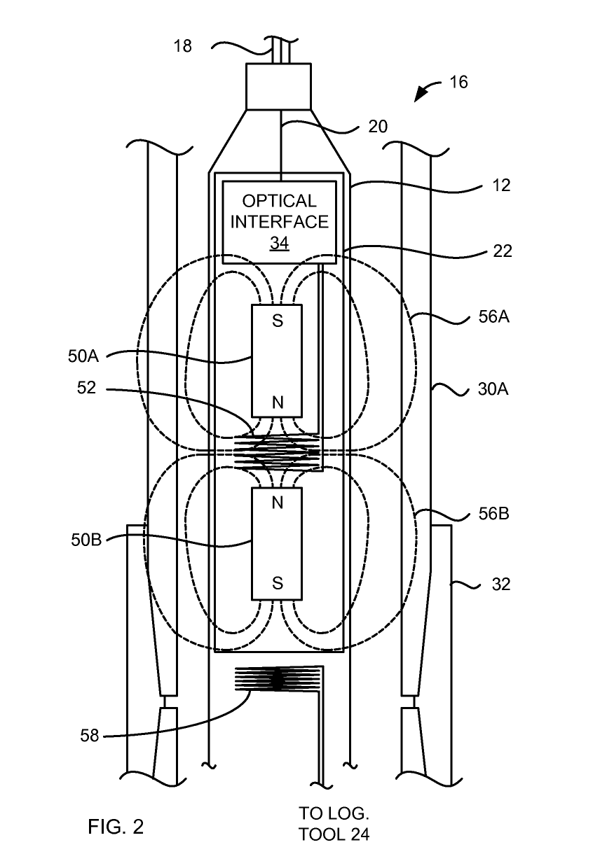

FIG. 2 provides a more detailed version of a first illustrative CCL tool embodiment. In the embodiment of FIG. 2, the CCL tool 22 includes a pair of opposed permanent magnets 50A and 50B and a wire coil 52 having multiple windings, the coil 52 serving as the sensor 36 of FIG. 1. The coil 52 is positioned between the magnets 50A and 50B to detect changes in the magnetic field produced by magnets 50A, 50B. In the embodiment of FIG. 2, each of the magnets 50A and 50B is cylindrical and has a central axis. The magnets 50A and 50B are positioned on opposite sides of the coil 52 such that their central axes are colinear, and the north magnetic poles of the magnets 50A and 50B are adjacent one another and the coil 52. A central axis of the coil 52 is colinear with the central axes of the magnets 50A and 50B. The coil 52 has two ends coupled to the optical interface 34.

The magnet 50A produces a magnetic field 56A that passes or “cuts” through the windings of the coil 52, and the magnet 50B produces a magnetic field 56B that also cuts through the windings of the coil 52. The magnet 50A and the adjacent walls of the casing string 16 form a first magnetic circuit through which most of the magnetic field 56A passes. Similarly, the magnetic field 56B passes through a second magnetic circuit including the magnet 50B and the adjacent walls of the casing string 16. The intensities of the magnetic fields 56A and 56B depend on the sums of the magnetic reluctances of the elements in each of the magnetic circuits.

Any change in the intensities of the magnetic field 56A and/or the magnetic field 56B cutting through the coil 52 causes an electrical voltage to be induced between the two ends of the coil 52 in accordance with Faraday's Law of Induction. As the sonde 12 of FIG. 2 passes through a casing section of the casing string 16 (e.g., the casing section 30A), the intensities of the magnetic fields 56A and 56B cutting through the coil 52 remain substantially the same, and no appreciable electrical voltage is induced between the two ends of the coil 52. On the other hand, as the sonde 12 passes by a collar (e.g., the collar 32), the magnetic reluctance of the casing string 16 changes, causing the intensities of the magnetic fields 56A and 56B cutting through the coil 52 to change in turn, and an electrical voltage to be induced between the two ends of the coil 52. FIG. 3 is an illustrative graph of the electrical voltage that might be produced between the two ends of the coil 52 as the sonde 12 passes by collar 32. This signal is the location signal produced by the CCL tool 22 as described above.

In the embodiment of FIG. 2, the sonde 12 also includes a second wire coil 58 coupled to the logging tool 24. The logging tool 24 drives coil 58 with an electrical telemetry signal that conveys gathered information. In response to the electrical telemetry signal, the coil 58 produces a modulated magnetic field (e.g., the modulated magnetic field 38 of FIG. 1) that couples with coil 52 to convey the information gathered by the logging tool 24. The logging tool 26 may include a similar coil, and may produce a similar modulated magnetic field (e.g., the modulated magnetic field 40 of FIG. 1) to convey its gathered information. Alternatively, the logging tool 26 may transmit gathered information to the logging tool 24, and the logging tool 24 may modulate the magnetic field produced by the coil 58 such that the modulated magnetic field conveys information gathered by both the logging tool 24 and the logging tool 26.

As shown in FIG. 2, the coil 58 is positioned near the permanent magnet 50B such that the modulated magnetic field produced by the coil 58 affects or perturbs the magnetic field 56B produced by the magnet 50B, and the change in the magnetic field 56B causes a change in the magnetic field 56A produced by the magnet 50A. As a result, the intensities of the magnetic fields 56A and 56B cutting through the coil 52 are changed, and an electrical voltage is induced between the two ends of the coil 52. The electrical signal produced by the coil 52 thus includes the electrical location signal, attributable to passing collars (e.g., the collar 32) in the casing string 16, and the electrical telemetry signal attributable to the electromagnetic telemetry signal transmitted by the logging tool 24.

In other embodiments, the CCL tool 22 may include a single permanent magnet producing a magnetic field that changes in response to passing a collar in the casing string. Suitable single magnet embodiments are shown and described in co-pending U.S. patent application Ser. No. 13/226,578 entitled “OPTICAL CASING COLLAR LOCATOR SYSTEMS AND METHODS” and filed Sep. 7, 2011, incorporated herein by reference in its entirety.

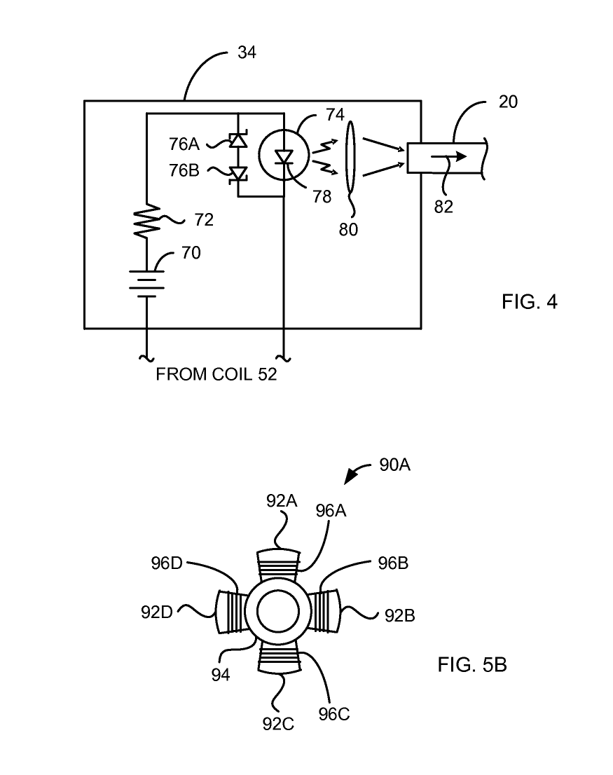

FIG. 4 is a diagram of an illustrative embodiment of the optical interface 34 of FIG. 2. In the embodiment of FIG. 4, the optical interface 34 includes a voltage source 70, a resistor 72, a light source 74, and a pair of Zener diodes 76A and 76B. The light source 74 includes a light emitting diode (LED) 78. The voltage source 70, the resistor 72, the LED 78, and the coil 52 (see FIG. 2) are connected in series, forming a series circuit. The voltage source 70 is a direct current (DC) voltage source having two terminals, and one of the two terminals of the voltage source 70 is connected to one end of the coil 52 (see FIG. 2). In the embodiment of FIG. 4, the LED 78 has two terminals, one of which is connected to the other of the two ends of the coil 52. The resistor 72 is connected between the voltage source 70 and the LED 78, and limits a flow of electrical current through the LED 78.

The voltage source 70 produces a DC bias voltage that at least partially forward-biases the LED 78, improving the responsiveness of the light source 74. The voltage source 70 may be or include, for example, a chemical battery, a fuel cell, a nuclear battery, an ultra-capacitor, or a photovoltaic cell. In some embodiments, the voltage source 70 produces a DC bias voltage that causes an electrical current to flow through the series circuit including the voltage source 70, the resistor 72, the LED 78, and the coil 52 (see FIG. 2), and the current flow through the LED 78 causes the LED 78 to produce light. A lens 80 directs at least some of the light produced by the LED 78 into an end of the optical fiber(s) 20 (see FIG. 2) to form the optical signal, labeled ‘82’ in FIG. 4. The optical signal 82 propagates along the optical fiber(s) 20 to the surface unit 28 (see FIG. 1). The surface unit 28 processes the optical signal 82 to obtain the casing collar locator signal and telemetry signals (i.e., transmitted information) from the logging tools 24 and 26.

Changes in the strengths of the magnetic fields 56A and 56B induce positive and negative voltage pulses between the ends of the coil 52 (see FIG. 2). Within the series circuit including the voltage source 70, the resistor 72, the LED 78, and the coil 52, the voltage pulses produced between the ends of the coil 52 are summed with the DC bias voltage produced by the voltage source 70. In some embodiments, a positive voltage pulse produced between the ends of the coil 52 causes a voltage across the LED 78 to increase, and the resultant increase in current flow through the LED 78 causes the LED 78 to produce more light (i.e., light with a greater intensity). Similarly, a negative voltage pulse produced between the ends of the coil 52 causes the voltage across the LED 78 to decrease, and the resultant decrease in the current flow through the LED 78 causes the LED 78 to produce less light (i.e., light with a lesser intensity). In these embodiments, the DC bias voltage produced by the voltage source 70 causes the optical signal 82 produced by the optical interface 34 to have an intensity that is proportional to a magnitude of an electrical signal produced between the ends of the coil 52.

The Zener diodes 76A and 76B are connected in series with opposed orientations as shown in FIG. 4, and the series combination is connected between the two terminals of the LED 78 to protect the LED 78 from excessive forward and reverse voltages. In other embodiments, the light source 74 may be or include, for example, an incandescent lamp, an arc lamp, a semiconductor laser, or a super-luminescent diode. In other embodiments, the DC bias voltage produced by the voltage source 70 may match a forward voltage threshold of one or more diodes in series with the light source 74.

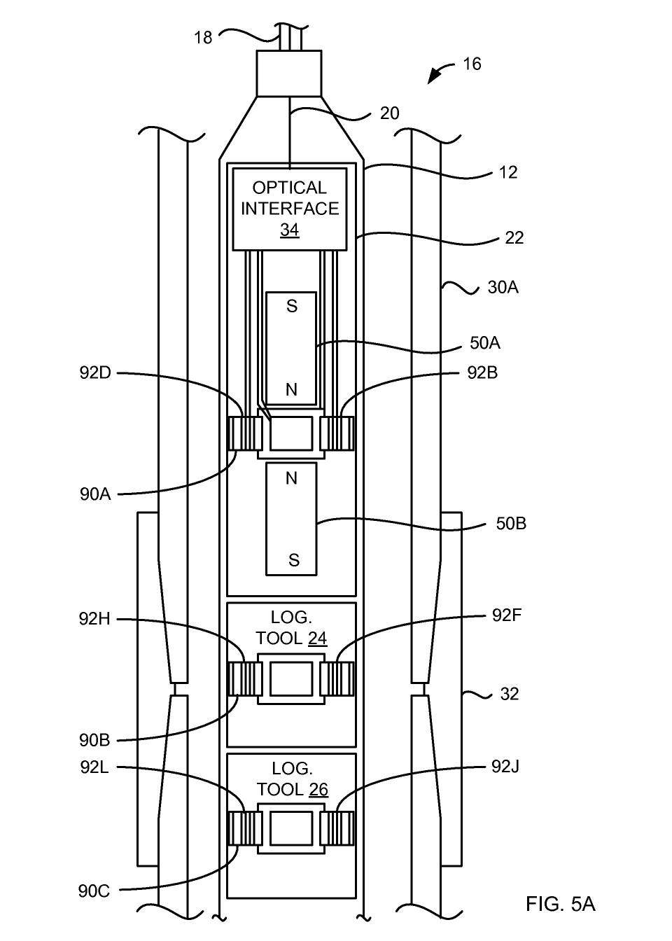

FIG. 5A is a diagram of another embodiment of the sonde 12 of FIG. 2. In the embodiment of FIG. 5A, a ferrite “star” 90A replaces the coil 52 positioned between the magnets 50A and 50B. FIG. 5B shows a top view of the ferrite star 90A of FIG. 5A. Referring to FIG. 5B, the ferrite star 90A has four azimuthally-distributed legs 92A, 92B, 92C, and 92D projecting radially outward from a central hub 94. A wire coil is positioned around each of the legs (coils 96A-96D), each coil being individually coupled to the optical interface 34 as indicated in FIG. 5A. The ferrite star 90A is made of a ferromagnetic material, and the legs concentrate the magnetic fields 56A and 56B produced by the magnets 50A and 50B (see FIG. 2) into azimuthal lobes that cut through the windings of the corresponding coils 96A-96D, thereby providing azimuthal sensitivity to the measurements by any given coil. Any change in the intensity of the magnetic field 56A and/or the magnetic field 56B cutting through one of the coils 96A-96D causes an electrical voltage to be induced between the two ends of the coil.

In the embodiment of FIG. 5A, each of the four coils 96A-96D produces an electrical casing collar locator signal, and the optical interface 34 produces four corresponding optical casing collar locator signals. The optical interface 34 may, for example, produce the four corresponding optical casing collar locator signals using different wavelengths of light such that each of the optical signals occupies a different portion of an optical frequency range. The surface unit 28 may recover the four separate electrical casing collar locator signals from the respective portions of the optical frequency range.

As the sonde 12 of FIG. 5A passes through the casing string 16, the sonde 12 can move laterally within the casing string 16. As the sonde 12 passes through a casing section (e.g., the casing section 30A) of the casing string 16, the intensities of the magnetic fields 56A and 56B cutting through the coils 96A-96D change with a changing distance between the coils 96A-96D and an inner surface of the casing string 16. The relative amplitudes of the respective electrical location signals will vary in a pattern that can be used to determine the sonde's lateral position within the casing. As the sonde 12 passes by a collar (e.g., the collar 32), the magnetic reluctance of the casing string 16 changes, causing the intensities of the magnetic fields 56A and 56B cutting through the coils 96A-96D to change, and inducing electrical voltages between the ends of the coils 96A-96D. The coils 96A-96D closest to the inner wall of the casing string 16 expectedly produce electrical voltages having the greatest magnitudes, and the coils 96A-96D farthest from to the inner wall of the casing string 16 expectedly produce electrical voltages having the smallest magnitudes.

In the embodiment of FIG. 5A, the logging tool 24 has a ferrite star 90B similar to the ferrite star 90A, and the logging tool 26 has a ferrite star 90C similar to the ferrite star 90A. The ferrite star 90B has four legs 92E, 92F, 92G, and 92H projecting radially outward from a central hub, and coils 96E-96H are positioned around the respective legs 92E-92H. The ferrite star 90C has four legs 92I, 92J, 92K, and 92L projecting radially outward from a central hub, and coils 96I-96L are positioned around the respective legs 92I-92L. The central hubs of the ferrite stars 90A, 90B, and 90C have central axes that are collinear, and corresponding legs of the ferrite stars 90A, 90B, and 90C are aligned along the collinear central axes such that the strengths of the magnetic couplings between the corresponding legs are relatively strong. The corresponding legs are: 92A, 92E, and 92I; 92B, 92F, and 92J; 92C, 92G, and 92K; and 92D, 92H, and 92L, and the corresponding coils are: 96A, 96E, and 96I; 96B, 96F, and 96J; 96C, 96G, and 96K; and 96D, 96H, and 96L.

The logging tool 24 drives an electrical telemetry signal that conveys gathered information on at least one of the coils 96E-96H. In response to the electrical telemetry signal, at least one of the coils 96E-96H produces a modulated magnetic field conveying information gathered by the logging tool 24. The modulated magnetic field produced by the at least one of the coils 96E-96H cuts through a corresponding at least one of the coils 96A-96D of the CCL tool 22, and an electrical voltage is induced between the ends of the corresponding at least one of the coils 96A-96D. The electrical signal produced by the corresponding at least one of the coils 96A-96D thus includes the electrical location signal, attributable to passing collars (e.g., the collar 32) in the casing string 16, and the electrical telemetry signal attributable to the electromagnetic telemetry signal transmitted by the logging tool 24. The logging tool 26 transmits an the electromagnetic telemetry signal to the CCL tool 22 in a similar manner. In some embodiments, different corresponding coils are assigned to the logging tools 24 and 26 for the transmission of gathered information.

The coils 96E-96H of the logging tool 24, and the coils 96I-96L of the logging tool 26 may be coupled together in appropriate polarities to achieve one of several orthogonal transmission modes. The four-coil embodiments can support the monopole mode, X-dipole mode, Y-dipole mode, and quadrupole mode, as four orthogonal signaling modes. In other words, representing the relative magnitude and polarity of the signals on coils A, B, C, D in FIG. 5B as a vector [A, B, C, D], the four orthogonal signaling modes could be [1, 1, 1, 1], [1, 0, −1, 0], [0, 1, 0, −1], and [1, −1, 1, −1]. Upon reception by an azimuthally-aligned set of coils, the coil signals would be combined with the appropriate magnitudes and polarities to extract the signals sent via the chosen modes. More information on orthogonal transmission modes can be found in “Multiconductor Transmission Line Analysis”, by Sidney Frankel, Artech House Inc., 1977, “Analysis of Multiconductor Transmission Lines (Wiley Series in Microwave and Optical Engineering), Clayton R. Paul, 1994, and in U.S. Pat. No. 3,603,923 dated Sep. 10, 1968 by Nulligan.

The orthogonal transmission modes can be used to support simultaneous half duplex and/or full duplex communication between the CCL tool 22 and multiple logging tools 24, 26. That is, the logging tools 24 and 26 may use different ones of the orthogonal transmission modes to communicate the gathered information to the CCL tool 22. The orthogonal transmission mode selected for each tool may be configurable and may, for example, be set when the sonde is assembled.

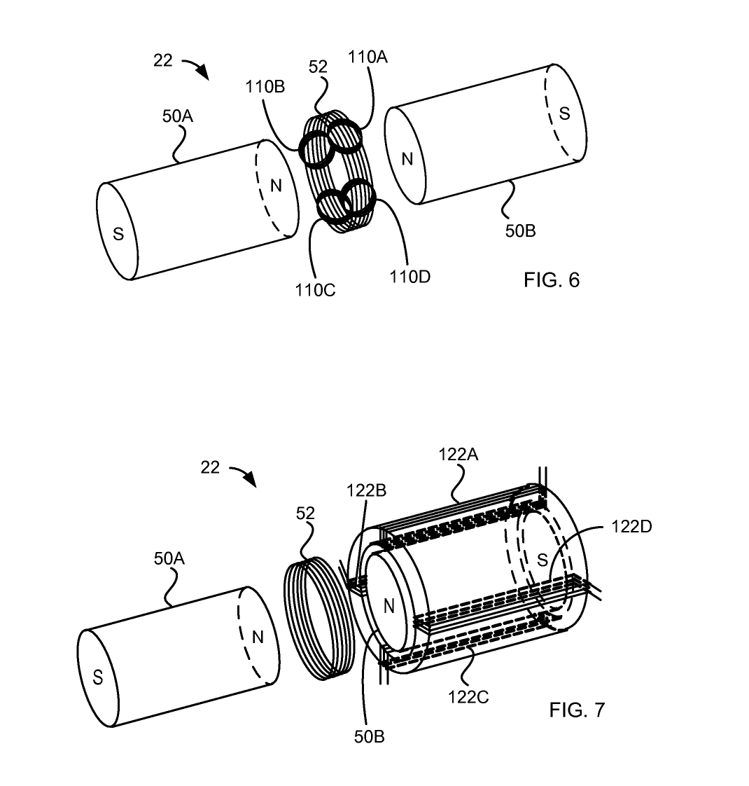

FIG. 6 shows an alternative embodiment of the CCL tool 22. In the embodiment of FIG. 6, the coil 52 is positioned between the magnets 50A and 50B as in FIG. 2 and described above. Four communication coils 110A, 110B, 110C, and 110D surround the coil 52 such that central axes of the coils 110A-110D and extend radially from the central axis of the coil 52. The coils 110A-110D are azimuthally distributed about the central axis of the coil 52, similar to the coils of FIG. 5A. The optical interface 34 measures the responses of each of the coils and communicates them to the surface. Coil 52 responds to passing collars to provide a location signal as described previously, and may further respond to telemetry signals from other logging tools. The communications coils 110A, 110B, 110C, and 110D respond to other component of the magnetic field, providing additional degrees of freedom for providing orthogonal transmission modes that would support simultaneous communications with multiple logging tools. (Of course, time or frequency multiplexing could also or alternatively be employed for this purpose.) The logging tools 24 and 26 would have communication coils similar to communication coils 110A-110D.

FIG. 7 shows another alternative embodiment of the CCL tool 22. In the embodiment of FIG. 7, the coil 52 is positioned between the magnets 50A and 50B as shown in FIG. 2 and described above. A hollow, cylindrical form 120 made of a non-magnetic material is positioned about the magnet 50B. The magnet 50B and the form 120 are coaxial, and in the embodiment of FIG. 7 the form 120 extends a length of the magnet 50B. Four communication coils 122A, 122B, 122C, and 122D are wound about the form 120 at equal distances along the form's perimeter (at equal angles about a central axis of the form 120). As with the communication coils of FIG. 6, each coil is coupled to the optical interface to respond to different components of the magnetic field and thereby provide additional degrees of freedom for supporting additional signal transmission modes. The logging tools 24, 26 would have similarly oriented communication coils for optimal coupling.

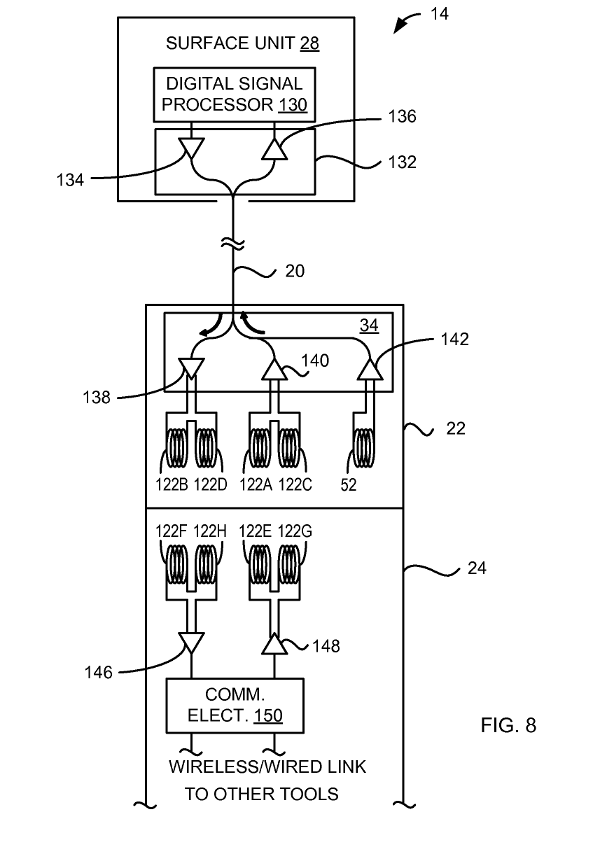

FIG. 8 shows an illustrative wireline tool system 14 that supports full-duplex communications. In the embodiment of FIG. 8, the CCL tool 22 includes the coil 52 and the communication coils 122A-122D shown in FIG. 7 and described above. Logging tool 24 includes a set of communication coils 122E-122H similar to coils 122A-122D. Corresponding coils are: 122A and 122E, 122B and 122F, 122C and 122G, and 122D and 122H. Magnetic couplings between corresponding coils is relatively strong.

In the embodiment of FIG. 8, the surface unit 28 includes an optical interface 132 coupled between a digital signal processor (DSP) 130 and the optical fiber(s) 20. The optical interface 132 includes an optical transmitter 134 and an optical receiver 136, both coupled to the DSP 130 and the optical fiber(s) 20. The optical interface 34 of the CCL tool 22 includes an optical receiver 138, an optical transmitter 140 for telemetry signals, and an optical transmitter 142 for a location signal. The logging tool 24 includes a receiver 146, a transmitter 148, and communication electronics 150. Each of the optical transmitters 134, 140, and 142 includes a light source (e.g., an incandescent lamp, an arc lamp, an LED, a semiconductor laser, and/or a super-luminescent diode). Each of the optical receivers 136 and 138 includes at least one photodetector (e.g., a photodiode, a photoresistor, a charge-coupled device, and/or a photomultiplier tube).

In the embodiment of FIG. 8, the coils 122A-122D and the coils 122E-122H are configured and operated to achieve a full duplex dipole transmission mode. One end of the coil 122A is connected to one end of the coil 122C such that electrical voltages induced between the ends of the coils 122A and 122C add together (reinforce one another), and the sum of the voltages is present between the other “free” ends of the coils 122A and 122C. Ends of the coils 122B and 122D, 122E and 122G, and 122F and 122H are connected similarly.

An “upgoing” transmission of the location signal from the CCL tool 22 to the DSP 130 will now be described. As described above, the coil 52 produces the location signal when the sonde 12 including the CCL tool 22 passes a collar in the casing string 16 (see FIG. 1). As indicated in FIG. 8, the ends of the coil 52 are coupled to an input of the optical transmitter 142. An output of the optical transmitter 142 is coupled to the optical fiber(s) 20 via a splitter. The optical transmitter 142 receives the electrical location signal from the coil 52 at the input, and drives an optical signal conveying the location signal from the coil 52 on the optical fiber(s) 20.

An input of the optical receiver 136 in the optical interface 132 of the surface unit 28 is coupled to the optical fiber(s) 20 via a splitter. The optical receiver 136 receives the optical signal conveying the location signal from the CCL tool 22 at the input, and produces an electrical signal conveying the location signal at an output. The DSP 130 is coupled to the output of the optical receiver 136, and receives the electrical signal conveying the location signal from the optical receiver 136.

A “downgoing” communication path from the surface unit 28 to the logging tool 24 will now be described. The DSP 130 generates an electrical control signal, and provides the electrical control signal to the optical transmitter 134. The optical transmitter 134 receives the electrical control signal at an input. An output of the optical transmitter 134 is coupled to the optical fiber(s) 20 via the splitter. The optical transmitter 134 drives an optical signal conveying the control signal from DSP 130 on the optical fiber(s) 20.

The free ends of the coils 122B and 122D are coupled to an output of the optical receiver 138. An input of the optical transmitter 140 is coupled to the optical fiber(s) 20 via the splitter. The optical receiver 138 receives the optical signal conveying the control signal from the DSP 130, and drives an electrical signal conveying the control signal from the DSP 130 on the coils 122B and 122D at the output. In response to the electrical signal from the optical receiver 138, the coils 122B and 122D of the CCL tool 22 produce a changing magnetic field (i.e., an electromagnetic signal) conveying the control signal from the DSP 130. The corresponding coils 122F and 122H of the logging tool 24 receive the electromagnetic signal conveying the control signal from the DSP 130, and an electrical signal conveying the control signal from the DSP 130 is provided to an input of the receiver 146. The receiver 146 receives the electrical signal conveying the control signal from the DSP 130 at the input, equalizes it, and provides it to the logging tool's communications electronics 150. As indicated in FIG. 8, the communication electronics 150 of the logging tool 24 may be coupled to other logging tools via a wireless or wired communication link to relay the control information.

An “upgoing” communication path from the logging tool 24 to the surface unit 28 will now be described. The communication electronics 150 of the logging tool 24 is coupled to an input of the transmitter 148. The communication electronics 150 produces an electrical signal conveying information (e.g., an electrical telemetry signal conveying gathered data), and provides the electrical signal to the transmitter 148. The transmitter 148 receives the electrical signal at the input, and drives the communication coils 122E and 122G accordingly. The resulting electromagnetic signal induces a response in communications coils 122A and 122C, which are coupled to an input of the optical transmitter 140 in the CCL tool. An output of the optical transmitter 140 is coupled to the optical fiber(s) 20 via the splitter. The optical transmitter 140 receives the electrical signal conveying the information from the logging tool 24 at the input, and drives an optical signal conveying the information from the logging tool 24 on the optical fiber(s) 20.

In the surface unit 28, the optical receiver 136 receives the optical signal conveying the information from the logging tool 24 at the input, and produces an electrical signal conveying the information from the logging tool 24 at an output. The DSP 130 is coupled to the output of the optical receiver 136, and receives the electrical signal conveying the information from the logging tool 24.

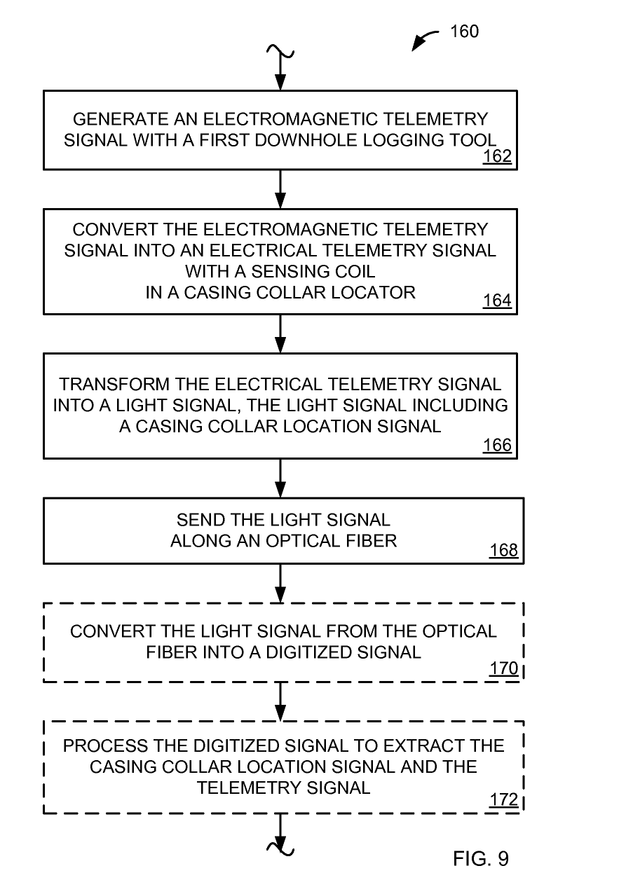

FIG. 9 is a flowchart of an illustrative telemetry method 160 that may be carried out by a wireline tool system (e.g., the wireline tool system 14 of FIG. 1). As represented by block 162, the method includes generating an electromagnetic telemetry signal with a first downhole logging tool (e.g., the logging tool 24 of FIGS. 1, 2, 5A, or 8). The method further includes converting the electromagnetic telemetry signal into an electrical telemetry signal with a sensing coil (e.g., the coil 52 of FIGS. 2, 6, and 7, or one of the coils 92A-92D of FIGS. 5A-5B) in a casing collar locator (e.g., the casing collar locator 22 of FIGS. 2, 5A, 6, or 7), as represented by block 164. The electrical telemetry signal is then transformed into a light signal where the light signal includes a casing collar location signal, as represented by block 166. The light signal is then sent along an optical fiber (e.g., one of the optical fiber(s) 20 of FIGS. 1, 2, 5A, or 8), as represented by block 168. Optionally, the received light signal from the optical fiber may be converted into a digitized signal, as represented by block 170. Optionally, the digitized signal may be processed to extract the casing collar location signal and the telemetry signal, as represented by block 172.

Numerous variations and modifications will become apparent to those skilled in the art once the above disclosure is fully appreciated. The foregoing description discloses a wireline embodiment for explanatory purposes, but the principles are equally applicable to, e.g., a tubing-conveyed sonde with an optical fiber providing communications between the sonde and the surface. In addition or alternatively to sensing communications signals from other logging tools in the sonde, the disclosed CCL tool can be employed for communications with other downhole tools, e.g., permanent sensors or downhole actuators. While the sonde is in proximity to such tools, the foregoing principles can be employed for communications between the surface and those tools. It is intended that the following claims be interpreted to embrace all such variations and modifications.

What is claimed is:

1. A wireline tool system that comprises:
at least one logging tool that collects information regarding a formation property or a physical condition downhole, wherein the at least one logging tool further provides a modulated magnetic field to communicate at least some of the collected information; and
a casing collar locator tool having:
a light source that transmits light along an optical fiber in accordance with a sensor signal; and
a sensor that provides said sensor signal in response to magnetic field changes attributable to passing collars in a casing string and in response to said modulated magnetic field.

2. The system of claim 1, further comprising a surface unit that processes light received via the optical fiber to obtain a casing collar locator signal and a telemetry signal.

3. The system of claim 1, wherein the sensor comprises at least one of: a magnetometer, a Hall-effect sensor, and a coil.

4. The system of claim 1, wherein the sensor comprises a sensing coil.

5. The system of claim 4, wherein the casing collar locator tool further comprises at least one permanent magnet producing a magnetic field that changes in response to passing a collar in the casing string.

6. The system of claim 4, wherein the light source comprises at least one of: an incandescent lamp, an arc lamp, an LED, a semiconductor laser, and a super-luminescent diode.

7. The system of claim 6, wherein the casing collar locator further comprises a voltage source that at least partially forward-biases the LED.

8. The system of claim 1, wherein the sensor is one of a set of azimuthally-distributed sensors that each respond to passing collars and a modulated magnetic field.

9. The system of claim 8, wherein each azimuthally-distributed sensor is a coil wound on a corresponding leg of a ferrite star.

10. A casing collar locator that comprises:
a locator coil that provides a location signal in response to magnetic field changes caused by passing a casing collar;
at least one communications coil that provides at least one communication signal in response to electromagnetic signals from one or more logging tools attached to the casing collar locator;
a circuit that produces a combined signal from the location signal and the at least one communication signal; and
a light source that converts the combined signal into light transmitted along an optical fiber.

11. The locator of claim 10, wherein the locator coil is oriented perpendicular to each communications coil.

12. The locator of claim 10, wherein multiple logging tools provide electromagnetic signals, and wherein the locator comprises multiple communications coils.

13. The locator of claim 10, wherein the electromagnetic signals are provided in a frequency band above an expected frequency range for the location signal.

14. A telemetry method that comprises:
generating an electromagnetic telemetry signal with a first downhole logging tool;
converting the electromagnetic telemetry signal into an electrical telemetry signal with a sensing coil in a casing collar locator;
transforming the electrical telemetry signal into a light signal, the light signal including a casing collar location signal; and
sending the light signal along an optical fiber.

15. The telemetry method of claim 14, further comprising:
converting a received light signal from the optical fiber into a digitized signal; and
processing the digitized signal to extract the casing collar location signal and the telemetry signal.

16. The telemetry method of claim 14, further comprising:
receiving a downgoing light signal from the optical fiber;
converting the downgoing light signal into a downgoing communication signal; and
retransmitting the downgoing communication signal as an electromagnetic signal.

17. The method of claim 16, wherein said retransmitting includes driving the downgoing communication signal on the sensing coil.

18. The method of claim 17, wherein the downgoing communication signal is separated in frequency from the telemetry signal to enable full duplex communication.

19. The method of claim 17, wherein the downgoing communication signal is separated in time from the telemetry signal to provide half duplex communication.
